(19) United States
(12) Patent Application Publication
(10) Pub. No.: US 2006/0045639 A1
(43) Pub. Date: Mar. 2, 2006

(54) Multiple-axis cutting toroidal end mill

(75) Inventors: Clifford M. Flynn, Pittsfield, MA (US); Louis A. Moser, Adams, MA (US); Jyrki T. Liedes, Andover, MA (US)

Correspondence Address: O'SHEA, GETZ & KOSAKOWSKI, P.C., 1500 MAIN ST., SUITE 912, SPRINGFIELD, MA, 01115, US

(73) Assignee: BERKSHIRE PRECISION TOOL, LLC, PITTSFIELD, MA (US)

(21) Appl. No.: 11/215,731

(22) Filed: Aug. 30, 2005

Related U.S. Application Data
(60) Provisional application No. 60/606,316, filed on Sep. 1, 2004.

(51) Int. Cl. B23C 5/10

(52) U.S. Cl. 407/54

(57) ABSTRACT

A one-piece toroidal end mill having an axis of rotation is provided. The end mill includes a shank section and a fluted section. The shank section extends along the axis of rotation. The fluted section extends along the axis of rotation, and has a first end, an outer surface, and a plurality of teeth. The first end is integrally attached to the shank section. Each of the plurality of teeth has a cutting surface and a shoulder surface. The cutting surface includes a cutting edge. The shoulder surfaces intersect with one another to form a center void disposed between the cutting surfaces.

This application claims the benefit of and incorporates by reference essential subject matter disclosed in U.S. Provisional Patent Application No. 60/606,316 filed on Sep. 1, 2004.

### BACKGROUND OF THE INVENTION

1. Technical Field

The present invention relates to end mills in general, and to single piece toroidal end mills in particular.

2. Background Information

There is a need for an effective alternative to current products that can utilize the rotational speeds and feed rates of modern machine tools in a production environment. Every machine shop is looking for ways to maximize its productivity within the operating parameters of its machine tools. Many cutting tool companies are bringing tools to market that, though very productive in theory, are often not practical in all applications and environments given the horsepower, torque, or rigidity restrictions required to properly utilize their geometries. Many of the machine tools currently in use, do not have the horsepower or torque capabilities required by these milling tools.

There is also a need for a tool that can help the domestic mold making industry. That tool must be able to machine small mold cavities in a productive manner.

It is known to use a toroidal end mill to rough pockets, cavities and cores at accelerated speeds and feeds over those typically used with a conventional style end mill. Another great use for a toroidal end mill is the finishing of a flat surface. A toroidal end mill used in circle interpolation with constant tool pressure in a “Z” axis can move at aggressive feed rate. Aggressive feed rates are also possible with a single axis movement. These movements permit the machining of hardened material, thereby creating an additional benefit.

Prior art toroidal end mills typically use carbide inserts. End mills with carbide inserts have several drawbacks, including: 1) increased tool cost; 2) potential for relative movement between an insert and the tool holder during the machining process, which can degrade the ability of the tool to hold specifications; 3) they typically have a negative rake angle that can undesirably plow work piece material during the machining process; 4) they typically have a shock value in machining that is less than a solid tool, and are therefore more susceptible to damage (e.g., inserts often break and dislodge from the tool holder, thereby possibly destroying the tool holder and damaging the part); 5) increased undesirable tolerance build-up; and 6) practical limitations regarding how small the diameter can be using inserts.

Where inserts are not used, manufacturers will often use a solid, ball nosed end mills. These ball nosed end mills have disadvantages as well. A ball nose end mill has a zero surface feet per minute (SFM) in the center of the end mill. In addition, when a ball mill is cutting material in a side movement the center drags, or when operating in a plugging or inward movement, the center of the ball mill comes under extreme force. Ball mills also often leave a less than desirable surface finish.

### SUMMARY OF THE INVENTION

According to the present invention, a one-piece toroidal end mill having an axis of rotation is provided. The end mill includes a shank section and a fluted section. The shank section extends along the axis of rotation. The fluted section extends along the axis of rotation, and has a first end, a second end opposite the first end, an outer surface, and a plurality of teeth. The first end is integrally attached to the shank section. Each of the plurality of teeth has a cutting surface and a shoulder surface. The cutting surface includes a cutting edge, and extends from the tip toward the shank section, between and contiguous with the shoulder surface and the outer surface. The shoulder surfaces intersect with one another to form a center void disposed between the cutting surfaces.

The present invention provides several advantages over prior art end mills with or without inserts. First, it is our experience that the present invention end mill increases the effective machining of machines with lower horsepower and torque capabilities. Such machines can achieve typically higher cubic inch removal rate per minute of operation with the present invention than they could achieve using a conventional end mill or insert standard tool. The higher cubic inch removal rates are achieved with light depth of cut (e.g., 80% of radius on toroidal end mill, for depth of cut) at high feeds rates per tooth or flute.

It is our further experience that accelerated speeds and feeds greater than that conventionally used for a given material, with shallow depth of cut, are possible with the present invention end mill. With the present invention solid design end mill, material specific end mills can be produced and remanufactured to meet the manufacturing needs without costly retooling. Such material specific end mills can be used to mill soft pre-hard and hardened die/steels, cast steels, cast iron, all stainless steels, nickel and titanium alloys, graphite and more. The present invention end mills can also be readily manufactured in forms having more than two flutes, thereby further increasing the feed rates possible with the tool.

The present invention toroidal end mill provides the following additional advantages: 1) increased insert shock value; 2) improved tolerance build-up relative to end mills utilizing inserts; 3) a more uniform end mill, that facilitates operator control in the machining of a part; 4) no inserts to lose and damage the tool holder and the machined part; 5) an end mill that can be resharpened; 6) an end mill that does not have a location along the cutting edge, center or side, where the velocity is zero during any cutting process; 7) an end mill that produces a desirable surface finish; 8) an end mill that can perform in a helical interpolation (cutting in three axes X, Y and Z at the same time) with no zero surface feet-per-minute causing toll failure; 9) an end mill with a cutting surface that creates a positive shear action in cutting of materials; 10) an end mill that can be manufactured with a cutting diameter that is so small that it is not practically attainable by an end mill utilizing inserts; 11) an end mill that can be indexed from flute to flute to decrease harmonic responses; and 12) an end mill that can be readily shaped to a variety of different configurations, including geometries not practically possible with inserts.

These and other features and advantages of the present invention will become apparent in light of the drawings and detailed description of the present invention provided below.

### BRIEF DESCRIPTION OF THE DRAWINGS

FIG. 1 is a diagrammatic view of an embodiment of the present invention end mill.

FIG. 2 is diagrammatic view of the end mill shown in FIG. 1, rotated 90 degrees.

FIG. 3 is an enlarged view of a portion of the end mill shown in FIG. 1.

FIG. 4 is an enlarged view of a portion of the end mill shown in FIG. 2.

FIG. 5 is a diagrammatic view of an embodiment of the present invention end mill.

FIG. 6 is diagrammatic view of the end mill shown in FIG. 5, rotated 90 degrees.

FIG. 7 is an enlarged view of a portion of the end mill shown in FIG. 5.

FIG. 8 is a diagrammatic view of an embodiment of the present invention end mill.

FIG. 9 is diagrammatic view of the end mill shown in FIG. 8, rotated 90 degrees.

FIG. 10 is a diagrammatic view of the fluted section of an embodiment of the present invention end mill.

FIG. 11 is diagrammatic view of the end mill shown in FIG. 10, rotated 90 degrees.

FIG. 12 is a diagrammatic view of the fluted section of an embodiment of the present invention end mill.

FIG. 13 is a diagrammatic end view of the fluted section of an embodiment of the present invention end mill.

FIG. 14 is a diagrammatic end view of the fluted section of an embodiment of the present invention end mill.

### DETAILED DESCRIPTION OF THE INVENTION

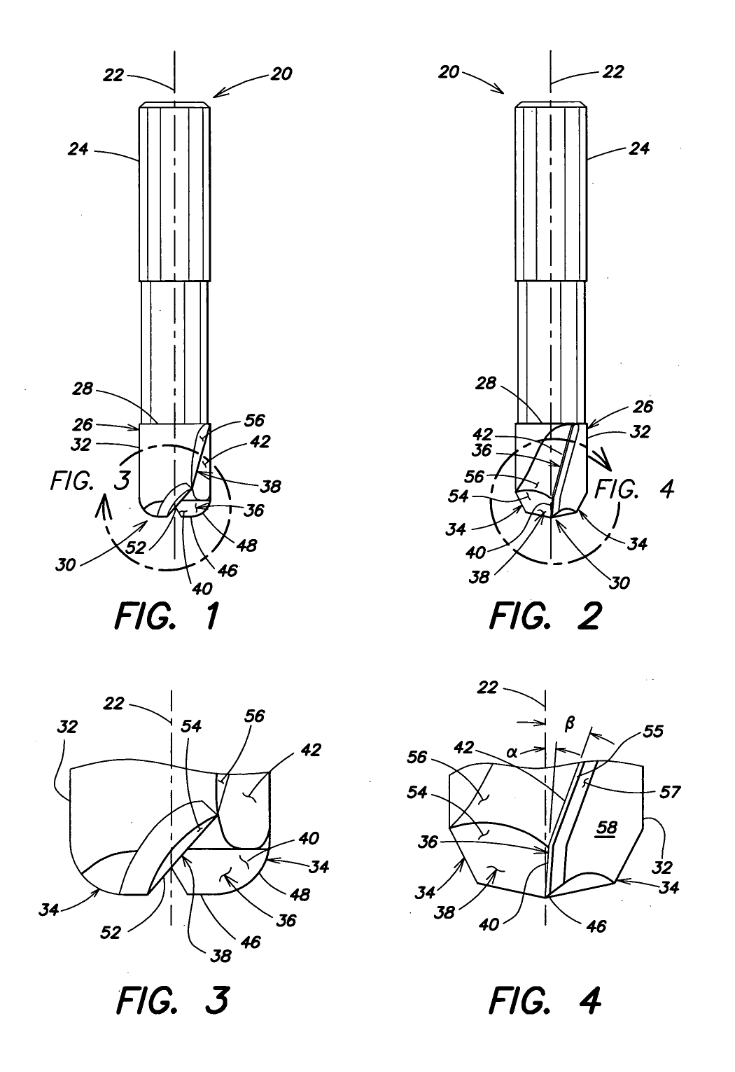

Referring to FIGS. 1-14, a one-piece toroidal end mill 20 having an axis of rotation 22 is provided. The end mill 20 includes a shank section 24 and a fluted section 26. The shank section 24 extends along the axis of rotation 22. The fluted section 26 extends along the axis of rotation 22, and has a first end 28 integrally attached to the shank section 24, a second end 30 (also referred to as the “tip”) opposite the first end 28, and an outer surface 32. The fluted section 26 includes a plurality of teeth 34. FIGS. 1-14 show embodiments of the present invention end mill 20 having a pair of teeth 34. Alternative embodiments may include more than two teeth 34. Each of the teeth 34 has a cutting surface 36 and a shoulder surface 38.

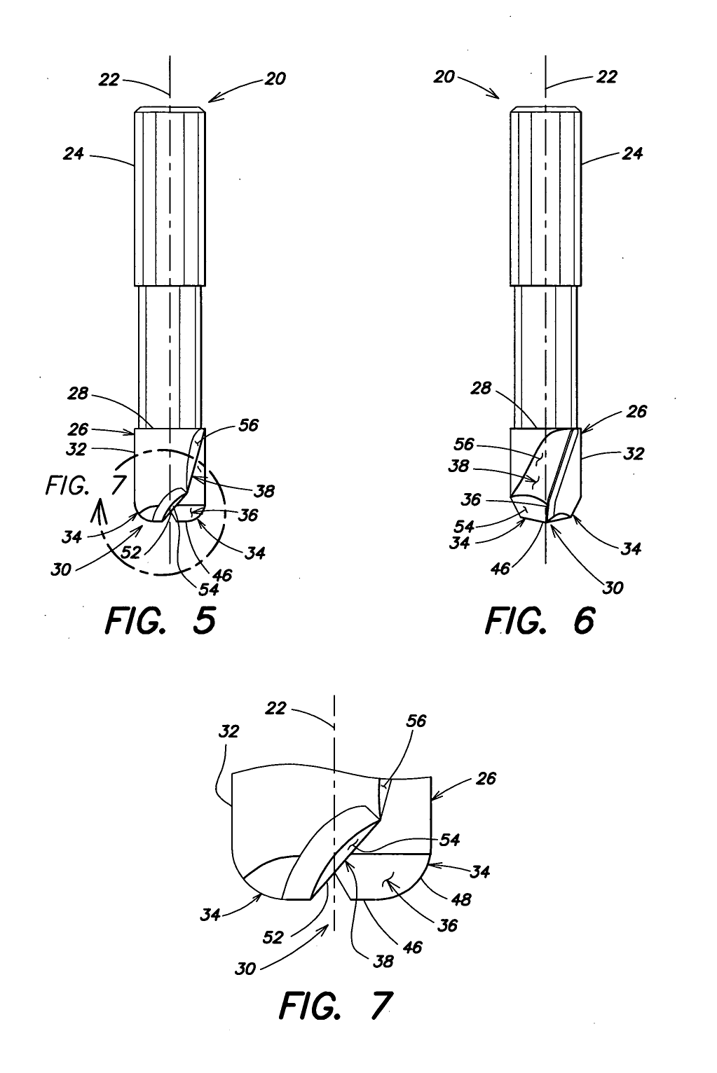

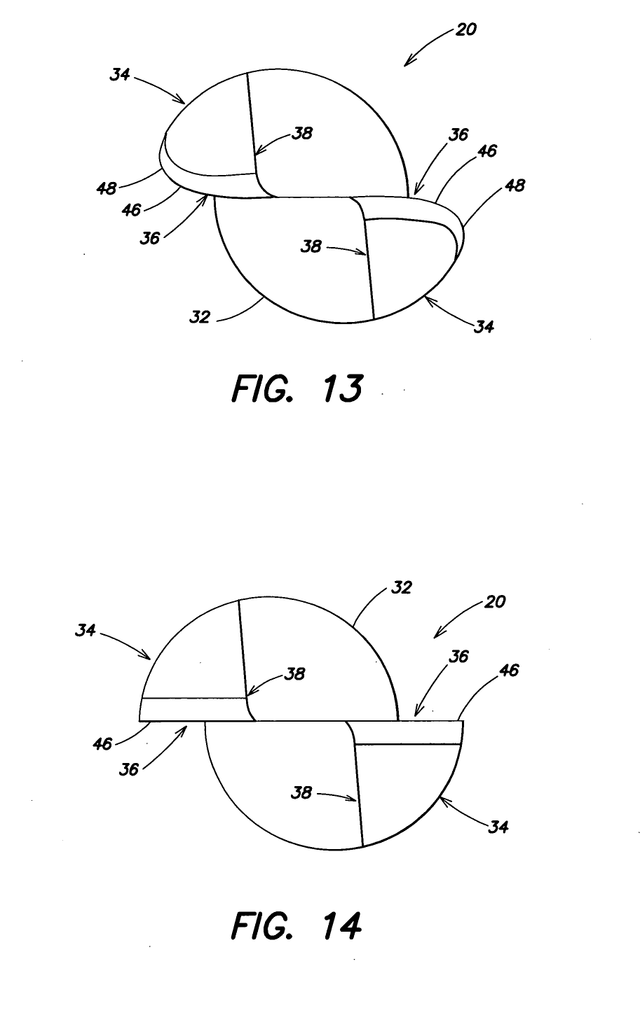

The cutting surface 36 extends from the tip 30 toward the shank section 24, between and contiguous with the shoulder surface 38 and the outer surface 32. In some embodiments, the cutting surface is disposed in one plane. For example, FIGS. 5-7 show an end mill having a cutting surface that is disposed in a single plane located in the region of the tip 30. In other embodiments, the cutting surface 36 is disposed in more than one plane. For example, the cutting surfaces 36 shown in FIGS. 1-4, 8, and 9 each include a first portion 40 and a second portion 42. The first portion 40 is disposed at a first rake angle and the second portion 42 is disposed at a second rake angle, greater than the first rake angle. The rake angle is defined as the angle disposed between a line within the plane of the cutting surface 36 (or portion thereof) and a line parallel to the axis of rotation 22 of the end mill 20. The end mill 20 shown in FIG. 4, for example, has a cutting surface first portion 40 disposed at a first angle “α” and a cutting surface second portion 42 disposed at a second angle “β”, where β>α. The cutting surface shown in FIG. 13 includes an arcuately shaped portion 48 that has a circumferentially-oriented curvature (as will be described below) and is therefore disposed in more than one plane.

The cutting surface 36 includes a cutting edge 46 that extends radially outward from the shoulder surface 38 toward the outer surface 32 of the tooth 34. In the embodiments shown in FIGS. 1-12, each tooth 34 is arcuately shaped for at least a portion 48 of the tooth 34 (including the cutting edge 46) that extends between the shoulder surface 38 and the outer surface 32. In the embodiments shown in FIGS. 1, 3, 5, 7, 8, 10 and 12, the arcuately shape portion 48 includes an “axially-oriented” curvature; i.e., a curvature that changes as a function of radial and axial position. The side view of FIGS. 1, 3, 5, 7, 8, 10 and 12 shows the axially-oriented curvature of the arcuately shaped portion 48. FIG. 13 illustrates another embodiment where the arcuately shaped portion 48 includes a “circumferentially-oriented” curvature; i.e., a curvature that changes as a function of radial and circumferential position. FIG. 14, in contrast, illustrates an end mill embodiment wherein the arcuately shaped portion 48 includes only an axially-oriented curvature (which cannot be seen in the end view of FIG. 14), and no circumferentially-oriented curvature. The arcuately shaped portion of some embodiments includes both an axially-oriented curvature and a circumferentially-oriented curvature. In the embodiments shown in FIGS. 1-14, the teeth 34 of the end mill each have an identical, or nearly identical, arcuately shaped portion 48; e.g., the arcuately shaped portion 48 for one tooth 34 has the same radius as that of the other tooth 34. The portion of each tooth 34 extending between the shoulder surface 38 and the outer surface 32 need not, however, be identical, or nearly identical to that of the other tooth 34. The arcuately shaped portions 48 may be, but are not necessarily, of a constant radius.

In addition, the arcuately shaped portion 48 may occupy less than the entire portion of the tooth 34 extending between the shoulder surface 38 and the outer surface 32. For example, each tooth 34 in the embodiment shown in FIGS. 1-9 has an initial portion, contiguous with the shoulder surface, that extends along a line that is substantially perpendicular to the end mill's axis of rotation 22. In those embodiments, the arcuately shaped portion 48 of each tooth 34 is approximately equal to twenty percent (20%) of the maximum diameter of the fluted section 26 of the end mill 20. In the embodiments shown in FIGS. 13-14, in contrast, the arcuately shaped portion 48 of each tooth 34 (e.g., the circumferentially-oriented portion) extending between the shoulder surface 38 and the outer surface 32 occupies a greater amount, thereby decreasing the size of the initial portion. In alternative embodiments, the arcuately shaped portion 48 of each tooth 34 extending between the shoulder surface 38 and the outer surface 32 may be sized such that there is no initial portion substantially perpendicular to the axis of rotation 22.

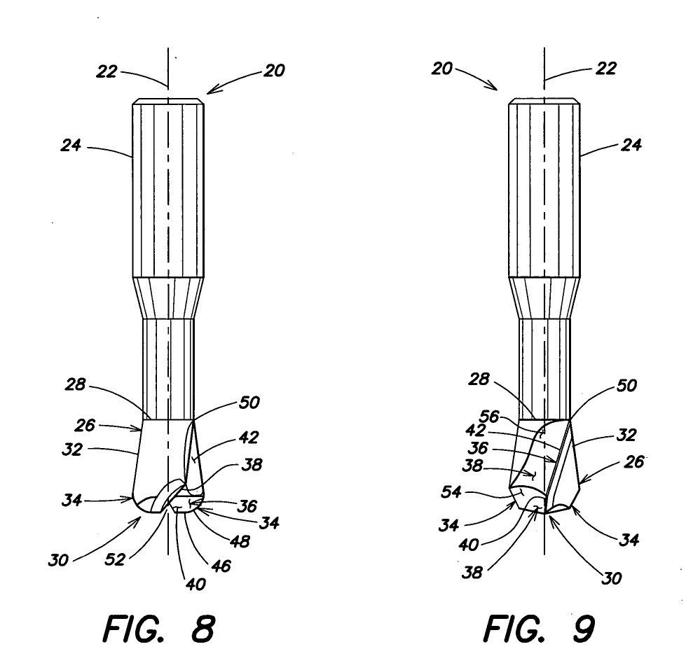

In some embodiments, a portion of the fluted section 26 is tapered radially inwardly. For example, the embodiment shown in FIGS. 8 and 9 shows a fluted section 26 having teeth 34 with a cutting surface 36 that tapers between a maximum outer diameter proximate the tip 30, and a less than maximum diameter disposed at the end 50 of the teeth 34 opposite the tip 30. The embodiments shown in FIGS. 1, 2, 5 and 6 have a fluted section 26 with no radial taper.

The shoulder surfaces 38 intersect with one another to form a center void 52 disposed between the cutting surfaces 36. The orientation of the center void 52 relative to the oppositely directed cutting surfaces 36 on the sides of the center void 52 facilitates chip removal and helps minimize undesirable machining marks.

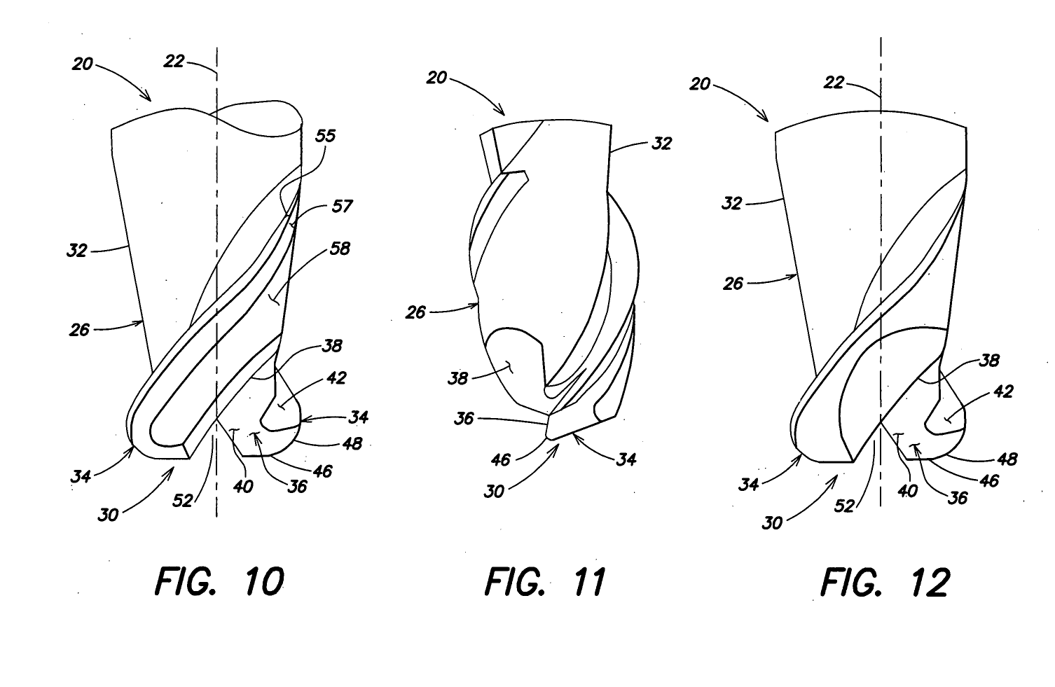

The shoulder surface 38 of each tooth 34 extends from the tip 30 toward the shank section 24, between and contiguous with the cutting surface 36 and the outer surface 32. In some embodiments, the shoulder surface 38 is disposed within a single plane. FIGS. 10 and 12 show embodiments having a single plane shoulder surface 38. In other embodiments, the shoulder surface 38 is disposed in more than one plane. For example, the embodiments shown in FIGS. 1-9 have a shoulder surface 38 with a first portion 54 and a second portion 56. The first portion 54 extends from the tip 30 to the second portion 56, and the second portion 56 extends there from to the outer surface 32.

The end mill 20 embodiments shown in FIGS. 4 and 10 each includes a primary relief 55, a secondary relief 57, and a tertiary relief 58 disposed in the outer surface 32. The tertiary relief 58 is disposed between the shoulder surface 38 and the secondary relief 57, the secondary relief 57 is disposed between the tertiary relief 58 and the primary relief 55, and the primary relief 55 is disposed between the secondary relief 57 and the cutting surface 36.

It will be obvious to those skilled in the art that various changes may be made without departing from the scope of the present invention and that the invention is not to be considered limited to what is described and exemplified in the specification.

What is claimed is:

1. A one-piece toroidal end mill having an axis of rotation, comprising:
a shank section extending along the axis of rotation;
a fluted section extending along the axis of rotation, having a first end integrally attached to the shank section, and an outer surface; and
a plurality of teeth disposed within the fluted section, each tooth having a cutting surface and a shoulder surface, the cutting surface having a cutting edge, and wherein the cutting surface for each tooth extends between, and is contiguous with, the shoulder surface for that tooth and the outer surface; and
wherein the shoulder surfaces intersect with one another to form a center void disposed between the cutting surfaces.

2. The end mill of claim 1, wherein the cutting surface of each tooth includes a first portion disposed at a first rake angle and a second portion disposed at a second rake angle.

3. The end mill of claim 2, wherein the first rake angle is less than the second rake angle.

4. The end mill of claim 1, wherein each tooth includes an arcuately-shaped portion disposed between the shoulder surface and the outer surface.

5. The end mill of claim 4, wherein the arcuately-shaped portion has an axially-oriented curvature.

6. The end mill of claim 5, wherein the arcuately-shaped portion has a circumferentially-oriented curvature.

7. The end mill of claim 4, wherein the arcuately-shaped portion has a circumferentially-oriented curvature.

8. The end mill of claim 4, wherein the arcuately-shaped portion of one of the plurality of teeth is substantially identical to the arcuately-shaped portion of the remainder of the plurality of teeth.

9. The end mill of claim 4, wherein the arcuately-shaped portion occupies less than the entire portion of the tooth extending between the shoulder surface and the outer surface.

10. The end mill of claim 10, wherein the portion of the tooth extending between the shoulder surface and the outer surface includes an initial portion contiguous with the shoulder surface that extends along a line that is substantially perpendicular to the axis of rotation.

11. The end mill of claim 1, wherein the fluted section is tapered radially inward.

12. The end mill of claim 11, wherein the fluted section has a tip and a diameter that is at its maximum proximate the tip, and wherein the fluted section tapers radially inward between the maximum diameter and the first end.

13. A one-piece toroidal end mill having an axis of rotation, comprising:
a shank section extending along the axis of rotation;
a fluted section extending along the axis of rotation, having an outer surface; and
a plurality of teeth disposed within the fluted section, each tooth having a cutting surface and a shoulder surface, the cutting surface having a cutting edge, and wherein the cutting surface for each tooth extends between, and is contiguous with, the shoulder surface for that tooth and the outer surface; and
wherein each tooth includes an arcuately-shaped portion disposed between the shoulder surface and the outer surface.

14. The end mill of claim 13, wherein the arcuately-shaped portion has an axially-oriented curvature.

15. The end mill of claim 13, wherein the arcuately-shaped portion has a circumferentially-oriented curvature.
